(19) United States
(12) Patent Application Publication
(10) Pub. No.: US 2013/0336354 A1
(43) Pub. Date: Dec. 19, 2013

(54) CHANNEL TYPE INDUCTION FURNACE

(71) Applicant: Louis Johannes Fourie, Centurion (ZA)

(72) Inventor: Louis Johannes Fourie, Centurion (ZA)

(21) Appl. No.: 14/002,324

(22) PCT Filed: Feb. 29, 2012
(86) PCT No.: PCT/IB12/50938

§ 371 Date: Aug. 29, 2013

(30) Foreign Application Priority Data
Mar. 1, 2011 (ZA) 2010/08674
Mar. 2, 2011 (ZA) 2010/07936
Sep. 6, 2011 (ZA) 2011/06486

(51) Int. Cl. F27B 14/20; F27B 14/06; F27B 14/08; H05B 6/20

(52) U.S. Cl. CPC F27B 14/20; H05B 6/20; F27B 14/065; F27B 14/0806
USPC 373/142; 373/162

(57) ABSTRACT

The invention comprises a double loop channel type induction furnace of which the floor has a base on a first side of its hearth and a ramp which rises from the base to terminate in a plateau above the passages at a location distal from the first side. The ramp and plateau extends at least partly between opposing end walls of the furnace, and the plateau includes a trench which extends at least partly between opposing ends of the plateau. The trench is in fluid communication with the passages and the bottom of the trench is located in a plane higher than the plane in which the furnace floor is located. The base of the furnace floor is in fluid communication with the central passage by means of a floor passage that extends from the base of the floor to the central passage through the ramp below the trench.

### FIELD OF THE INVENTION

This invention relates to channel type induction furnaces used in the melting or smelting of metals and particularly to induction furnaces used in smelting particulate materials floating on the surface of the metal and slag.

### BACKGROUND TO THE INVENTION

Conventional channel induction furnaces fed with particulate material floating on the surface are designed with relatively deep metal baths. This is so because particulate material floating on the slag layer on top of a bath of molten metal is a poor heat sink which leads to higher metal temperatures and recirculation of heated metal back into the channel heater. This results in overheating of the molten metal and damage to the refractory material lining, if the furnace is designed to operate with a shallow metal bath. A shallow bath also results in relatively cold areas where the melting rate is relatively much slower than in the area directly above the channel heater.

On the other hand a deep metal bath has the disadvantage that more metal must be kept in the furnace, leading to greater heat losses than when a shallow metal bath is used and an unnecessary high process inventory. Metal losses, damage to equipment and danger to personnel in the event of a metal leak is also unnecessarily high when using a deep metal bath.

Further, in an induction furnace with a deep metal bath strong convection currents are set up in the furnace during operation thereof. This results in unstable rapid melting of particulate materials in some areas while in other areas no melting occurs. It has been found that in operation melting particulate materials with a deep metal bath leads to areas of melting migration, in other words the areas where melting occurs move around in the furnace, resulting in unstable flow and melting conditions.

A previous attempt to overcome this problem, as set out in SA patent 2002/10025, was successful but the cost and start-up problems rendered this solution difficult to apply in practice.

This invention comprises developments on the inventions described in South African provisional patent application numbers 2010/07936 and 2010/08674, the full specifications of which are included herein by reference and inclusion in annexures A and B hereto, to fully form part of the subject of this current application.

### OBJECT OF THE INVENTION

It is an object of the invention to provide a channel type induction furnace and a liquid metal flow control device which at least partly overcomes the abovementioned problem.

### SUMMARY OF THE INVENTION

In accordance with this invention there is provided a double loop channel type induction furnace comprising a shell lined with refractory material, and having a floor and a wall extending from the floor to form a hearth, at least one induction heater associated with the furnace and communicating with the hearth by means of a throat in the floor, the throat including a central passage serving as an inlet to the induction heater and two side passages on opposite sides of the central passage serving as outlets from the induction heater, the throat passages being complimentary shaped and configured to channels in the induction heater and each passage being in fluid communication with a complimentary channel, the furnace floor having a base on a first side of the hearth and a ramp which rises from the base to terminate in a plateau above the passages at a location distal from the first side, with the ramp and plateau extending at least partly between opposing end walls of the furnace, the plateau including a trench which extends at least partly between opposing ends of the plateau, with the trench being in fluid communication with the passages and the bottom of the trench being located in a plane higher than the plane in which the furnace floor is located, and the base of the furnace floor being in fluid communication with the central passage by means of a floor passage that extends from the base of the floor to the central passage through the ramp below the trench.

There is further provided for the induction heater and the plateau to be located at a second side opposite the first side of the furnace.

There is further provided for the hearth to have an operating depth which corresponds with a liquid metal meniscus level that operatively is located high enough to cover the plateau with liquid metal.

There is further provided for the furnace to include at least one tapping hole, preferably located in an end wall of the furnace and further preferably located above the height of the plateau.

According to a further feature of the invention there is provided a method of operating a furnace as defined above containing a liquid metal bath, the method including charging feed material into the hearth proximate its first side to raise the liquid metal meniscus above the plateau, heating the liquid metal bath by means of the induction heater, and discharging molten liquid metal from the furnace and charging feed material into the hearth to substantially maintain the plateau covered by liquid metal.

According to a further feature of the invention there is provided a method of controlling the heating of a bath of liquid metal in a furnace as defined above by controlling the depth of liquid metal above the plateau to control the flow distance of heated metal from the induction heater through the trench.

According to a further feature of the invention, there is provided for the method of controlling the heating of a bath of liquid metal in a furnace as defined above to include controlling the size of the heap of feed material supported by the liquid metal bath to below a predetermined critical size, preferably by ensuring that an area of about 600 mm from the second side of the furnace above the plateau is clear of feed material.

These and other features of the invention are described in more detail below.

### BRIEF DESCRIPTION OF THE DRAWINGS

A preferred embodiment of the invention is described by way of example only and with reference to the accompanying drawings in which:

FIG. 1 is a part sectional top perspective view of a hearth of a furnace according to the invention;

FIG. 2 is a sectional perspective side view of the hearth of FIG. 1; and

FIG. 3 is a view of FIG. 2 which shows operating levels in respect of the liquid metal bath and feed material supported by it.

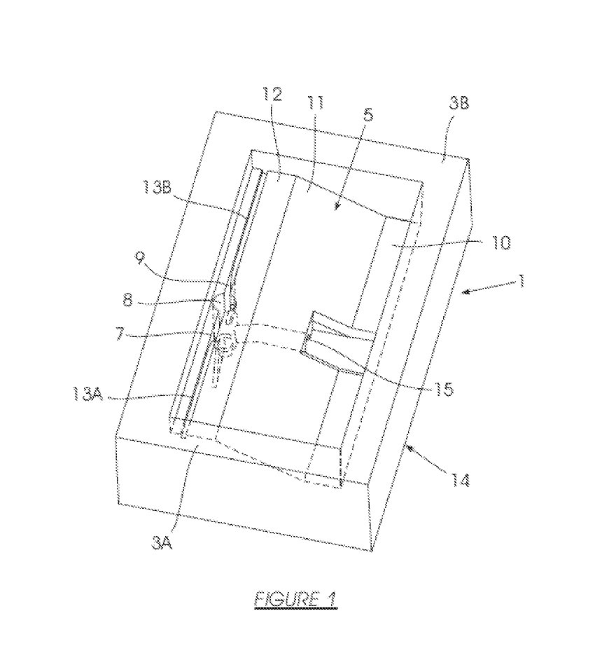

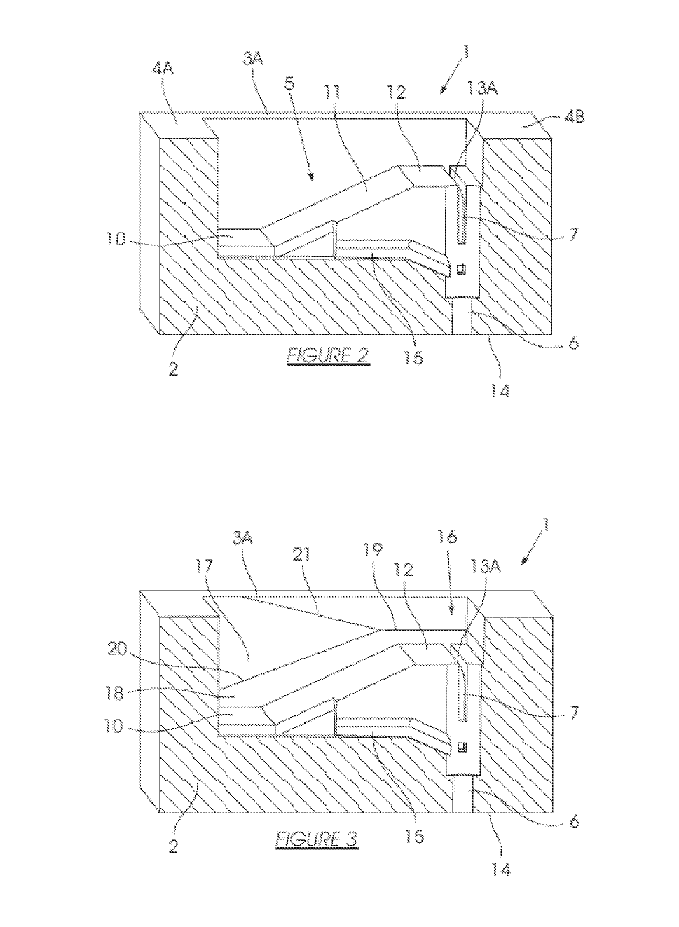

### DETAILED DESCRIPTION OF THE INVENTION

A portion of a preferred embodiment of a channel type induction furnace (1) according to the invention is shown in the drawings. As shown in the drawings, the furnace (1) includes a floor (2) with end walls (3A, 3B) and side walls (4A, 4B) extending from it which forms a hearth (5). A double loop induction heater (not shown for the sake of simplicity) is secured to the base (14) of the furnace (1) and communicates with the hearth (5) through a throat (6) in the furnace floor (2).

The throat (6) includes a central passage (8) which serves as an inlet into the induction heater. The throat (6) also includes two side passages (7, 9) on opposite sides of the central passage (8) which serve as outlets from the induction heater. The furnace (1) has a generally rectangular shape with the central passage (8) and two side passages (7, 9) located in a line along the length of the furnace floor (2).

The furnace floor (2) includes a base (10) proximate a first side of the hearth (5) adjacent the first side wall (4A), and a ramp (11) which rises from the base (10) to terminate in a plateau (12) proximate a second side of the hearth (5). The second side of the hearth (5) is located at the opposing side of the furnace (1) adjacent the second side wall (4B) above the throat passages (7, 8, 9).

The ramp (11) and plateau (12) extend between opposing end walls (3A, 3B) of the furnace (1). The plateau (12) includes a trench (13A, 13B) which extends between the end walls (3A, 3B). The trench (13) is in fluid communication with the throat passages (7, 8, 9). The bottom of the trench (13) is located higher in the hearth (5) than the base (10) of the furnace floor (2).

The base (10) of the furnace floor (2) is in fluid communication with the central passage (8) by means of a connecting passage (15) that extends from the floor base (10) to the central passage (8) through the ramp (11) below the trench (13) in the plateau (12).

In use liquid metal is heated in the channels of the induction heater through electrical resistance to the flow of electromagnetically induced electrical current in these channels. Cooler metal enters the central channel through the central passage (8) drawn from the bottom of the liquid metal bath through the connecting passage (15), while heated metal exits from the two outer channels through the outer throat passages (7, 9) towards the plateau (12). This is well known technology which requires no additional explanation.

The design of the ramp (11) and plateau (12) on the furnace floor (2) which guides the heated liquid metal following its exit from the side passages (7, 9) into the hearth (5) is believed best, and at least partly, to be described by the Coand [symbol] effect.

This effect describes the tendency of a fluid, either gaseous or liquid, to cling to a surface that is near an orifice from which the fluid emerges as a stream. An important part of the effect is the tendency of the primary flow of a fluid to entrain, or draw in, more fluid from the environment. Thus, a fluid emerging from a nozzle tends to follow a nearby curved surface, even to the point of bending around corners, if the curvature of the surface or the angle the surface makes with the stream is not too sharp.

The result of this is that the flow pattern of the fluid is influenced by a surface over which the fluid flows. The flow pattern of the fluid is also influenced by the medium into which it flows. In this instance the flowing fluid is heated metal and the medium is liquid metal at a lower temperature. The interaction between the flowing fluid and the medium causes the flowing fluid to spread out into the medium and to not flow unaffected through it as if it were a cylinder of fluid. The current invention allows manipulation of the flow pattern to determine where melting of burden will occur.

The passages (7, 9) and trench (13) are shaped to form a smooth trajectory for the stream of heated liquid metal to be directed horizontally above the plateau (12) towards the end walls (3A, 3B) of the furnace (1). Each of the side passages (7, 9) feeds into its corresponding portion (13A, 13B) of the trench (13), and the heated liquid metal flows from each side passage (7, 9) is thus directed by its own corresponding portion of the trench (13) towards its closest end wall (3A, 3B). The heated liquid metal flows over the plateau (12) and down the ramp (11), under the supported feed material (17) below the interface (20) between the supported feed material (17) and liquid metal bath (18) to melt and mix with the liquid metal bath (18) in the hearth (5). The feed material (17) rests on the liquid metal bath (18) at an angle, as indicated by the upper surface (21) of the feed material (17) on the liquid metal bath (18).

It has been found that by raising the bottom of the trench (13) to be above the base (10) of the floor (2), and by controlling the level (16) of the liquid metal bath above the plateau (12), the flow pattern of the heated liquid metal can be controlled.

It has further been found that by altering the level (16) of the metal bath above the plateau (12), the flow pattern of the heated liquid metal over the plateau (12) and down under the supported feed material (17) is changed. It is therefore possible in operation by trial and error to change the flow pattern of the heated liquid metal and hence the melting pattern of the supported feed material (17). Some optimum level is therefore determined in practice. A further method to influence the melting pattern of the material ( ), is to change the amount of material (17) in the furnace (1), thereby varying the width of the metal meniscus (19) which is not supporting feed material (17) and the contact surface area (20) between liquid metal and supported feed material (17).

Changing the amount of feed material (17) in the furnace (1) has the further effect of altering the depth to which the feed material (17), which is supported by the liquid metal bath (18), displaces liquid metal (18), which also influences the melting pattern in the furnace (1).

It has been established that for each furnace (1), and depending on its specific dimensions and the power of its induction heater, there is an optimum combination of level of liquid metal in the hearth (5) and amount of feed material (17) that allows for the optimal distribution of the heated liquid metal from the induction heater. This is optimal in the sense that the distribution of the heated liquid metal into the liquid metal bath (18) is spread out the best. This means the liquid metal bath (18) is heated most evenly by the liquid metal from the induction heater and the melting rate along the length of the furnace (1) is consistent.

It will be appreciated that the embodiment described above is not intended to limit the scope of the invention, and it is possible to include changes to the embodiment without departing from the scope of the invention.

It is for example possible to terminate the trenches before they reach the end walls of the furnace. This allows the heated liquid metal to be spread more evenly around areas proximate the walls, distal from the central passage. It is also possible to combine this with a widening of the trench, whilst retaining its depth, to slow down the speed of the liquid metal stream.

It should also be appreciated that the trenches allows the metal flow to be directed in any direction, even downwards, which is surprising since heated metal usually rises in a bath of liquid metal due to its lower density. This is achieved without the trench being covered, i.e. the trench is not a tube or a conduit in the conventional manner. If the trench were to be kept the same depth the stream of heated fluid could be directed over a surprisingly long distance.

A trench may thus be employed over any outlet to control the direction and distance of its flow from such outlet.

1.-10. (canceled)

11. A double loop channel type induction furnace comprising a shell lined with refractory material, and having a floor and a wall extending from the floor to form a hearth, at least one induction heater associated with the furnace and communicating with the hearth by a throat in the floor, the throat including a central passage serving as an inlet to the induction heater and two side passages on opposite sides of the central passage serving as outlets from the induction heater, the central and two side passages of the throat being complimentary shaped and configured to channels in the induction heater and each of the central and two side passages being in fluid communication with a complimentary channel, the floor having a base on a first side of the hearth and a ramp which rises from the base to terminate in a plateau above the central and two side passages at a location distal from the first side, with the ramp and plateau extending at least partly between opposing end walls of the furnace, the plateau including a trench which extends at least partly between the opposing ends of the plateau, with the trench being in fluid communication with the central and two side passages and the bottom of the trench operatively being located in a plane higher than the plane in which the floor is located, and the base of the floor being in fluid communication with the central passage by a floor passage that extends from the base of the floor to the central passage below the trench.

12. The furnace of claim 11 in which the floor passage extends through the ramp.

13. The furnace as claimed in claim 11 in which the induction heater and the plateau are located at a second side opposite the first side of the furnace.

14. The furnace as claimed in claim 11 in which the hearth has an operating depth which corresponds with a liquid metal meniscus level operatively located high enough to cover the plateau with liquid metal.

15. The furnace as claimed in claim 13 in which the hearth has an operating depth which corresponds with a liquid metal meniscus level operatively located high enough to cover the plateau with liquid metal.

16. The furnace as claimed in claim 11, further comprising at least one tapping hole.

17. The furnace as claimed in claim 16 in which the tapping hole is located in an end wall of the furnace.

18. The furnace as claimed in claim 17 in which the tapping hole is located above the height of the plateau.

19. The furnace of claim 15 which includes at least one tapping hole located in an end wall of the furnace above the height of the plateau.

20. A method of controlling the heating of a bath of liquid metal in a furnace as claimed in claim 11, the method including controlling the depth of liquid metal above the plateau to control the flow distance of heated metal from the induction heater through the trench, with a level of liquid metal above the plateau deeper than a critical depth resulting in a shorter flow distance, and a level of liquid metal above the plateau that is about the critical depth resulting in a longer flow distance, and a level of liquid metal above the plateau that is lower than the critical depth resulting in a shorter flow distance.

21. A method of controlling the heating of a bath of liquid metal in a furnace as claimed in claim 11, the method including controlling the size of the heap of feed material supported by the liquid metal bath to below a predetermined critical size.

22. A method of controlling the heating of a bath of liquid metal in a furnace as claimed in claim 11, the method including ensuring that that the metal bath surface above the plateau remains substantially uncovered by feed material.

23. A method of controlling the heating of a bath of liquid metal in a furnace as claimed in claim 11, the method including controlling the depth of liquid metal above the plateau to control the flow distance of heated metal from the induction heater through the trench, with a level of liquid metal above the plateau deeper than a critical depth resulting in a shorter flow distance, and a level of liquid metal above the plateau that is about the critical depth resulting in a longer flow distance, and a level of liquid metal above the plateau that is lower than the critical depth resulting in a shorter flow distance; controlling the size of the heap of feed material supported by the liquid metal bath to below a predetermined critical size, and ensuring that that the metal bath surface above the plateau remains substantially uncovered by feed material.

24. A method of operating a furnace as claimed in claim 11, which contains a bath of liquid metal, the method including charging feed material into the hearth proximate its first side to raise the liquid metal meniscus above the plateau, heating the liquid metal bath by the induction heater, discharging molten liquid metal from the furnace, and charging feed material into the hearth to substantially maintain the plateau covered by liquid metal.

25. The method of operating a furnace as claimed in claim 24, further comprising controlling the heating of the bath of liquid metal as claimed in claim 20.
